(19) United States
(12) Patent Application Publication
(10) Pub. No.: US 2026/0028753 A1
(43) Pub. Date: Jan. 29, 2026

(54) ELECTROSPINNING SYSTEMS FOR MASS PRODUCTION OF NANOFIBERS

(71) Applicant: Matregenix, Inc., Mission Viejo, CA (US)

(72) Inventor: Sherif Soliman, Irvine, CA (US)

(73) Assignee: Matregenix, Inc., Mission Viejo, CA (US)

(21) Appl. No.: 19/342,458

(22) Filed: Sep. 26, 2025

Related U.S. Application Data
(63) Continuation-in-part of application No. 19/045,673, filed on Feb. 5, 2025, now abandoned.
Application No. 19/045,673 is a continuation of application No. PCT/US2023/071801, filed on Aug. 7, 2023.
(60) Provisional application No. 63/370,643, filed on Aug. 5, 2022.

(51) Int. Cl. D01D 5/00; B82B 3/00; D01D 4/06

(52) U.S. Cl. CPC D01D 5/003; B82B 3/0009; D01D 4/06; D01D 5/0069; D01D 5/0076; D01D 5/0092

(57) ABSTRACT

The present disclosure describes electrospinning systems and apparatuses suitable for use in high throughput industrial settings. The disclosed systems and apparatuses may include a high voltage power supply having positive and negative electrodes; one or more spinnerets that include one or more convergent-divergent nozzles, one or more turbo canals, or a combination thereof; and a collector. The systems and apparatuses may further include one or more peristaltic pumps. In some implementations, the systems and apparatuses may be designed to produce nanofibers from multiple polymer solutions simultaneously. The collector may be an adjustable collector that is composed of multiple metal sheets. The collector may alternately be a conveyor belt collector. The systems and apparatuses may optionally further include one or more of a ventilation system that reduces sparking inside the electrospinning chamber, a chamber for reducing power consumption when using an optional heater or dehumidifier, and an in-line quality control system.

### CROSS-REFERENCE TO RELATED APPLICATIONS

This application is a continuation-in-part of U.S. patent application Ser. No. 19/045,673, filed on Feb. 5, 2025, which is a continuation of PCT Patent Application No. PCT/US2023/071801, filed on Aug. 7, 2023, which claims the benefit of U.S. Provisional Patent Application Ser. No. 63/370,643, filed on Aug. 5, 2022, the disclosures of which are hereby incorporated in their entireties herein by reference.

### BACKGROUND

### Field of the Invention

The present disclosure relates to electrospinning systems and apparatuses.

### Description of the Related Art

Electrospinning is the most commonly used method for producing nanofibers. The electrospinning process has been extensively studied on account of its potential applications in multiple industries. A wealth of scientific publications explore this area and there are many reasons to believe that nanofibers are a key solution for many applications, including textiles and clothing, military applications, tissue engineering, drug delivery, cancer diagnosis, batteries, optical sensors, and air filtration. Nonetheless, the adoption of electrospinning techniques in industry settings has been extremely slow and limited. This is primarily because electrospinning is perceived as a laboratory scale technique that is difficult to scale up, and thus it is often assumed that electrospinning cannot meet the high throughput demands of industrial applications. Production rates using typical electrospinning technology are usually around 0.01-1 g/h, which is lower than most industry production requirements.

The instrumentation necessary for electrospinning include a high voltage power supply, a spinneret, and a collector. The spinneret may be a capillary tube with a pipette or needle having a small diameter. The collector may be a metal collecting plate. One electrode of the high voltage power supply is placed into a polymer solution and the other electrode is attached to the collector. An electric field is applied to the end of the capillary tube that contains the polymer solution held by its surface tension and forms a charge on the surface of the liquid. As the intensity of the electric field increases, the hemispherical surface of the fluid at the tip of the capillary tube elongates, forming a conical shape known as a Taylor cone. A critical value is attained upon a further increase in the electric field, where the repulsive electrostatic force overcomes the surface tension and the charged jet of fluid is ejected from the tip of the Taylor cone. The discharged polymer solution jet is unstable and elongates as a result, allowing the jet to become very long and thin. Charged polymer fibers solidify with solvent evaporation. Randomly oriented nanofibers are collected on the collector. Nanofibers can also be collected in a highly aligned fashion using specialized collectors such as a rotating drum, metal frame, or a two-parallel plate system. Parameters such as jet stream movement and polymer concentration must be controlled to produce nanofibers with uniform diameters and morphologies.

Electrospinning may be used to transform many types of polymers into nanofibers. An electrospun nanofiber network resembles the extracellular matrix (ECM) in important ways. This resemblance is a major advantage of electrospinning, because it allows for mimicking the ECM with respect to fiber diameters, porosity, and mechanical properties. Electrospinning is being further developed for the mass production of one-by-one continuous nanofibers.

Current electrospinning technologies typically use a syringe pump to feed the polymer solution into the spinneret. Syringe pumps typically have limited flow rates and limited loading capacities, which necessitate stopping the electrospinning process to refill the syringes.

Current electrospinning technologies typically use a needle as the spinneret, limiting production capacity.

Current electrospinning apparatuses are generally limited to single-solution setups, restricting the ability to produce composite nanofibers in a controlled manner. Existing multi-solution systems are often based on multiple needles or sources, but these designs typically suffer from poor convergence of fiber jets and uneven deposition areas. Further, current approaches do not allow precise control of depositing one solution directly over another in a layer-by-layer manner. As a result, the formation of uniform multilayer nanofiber structures with different materials remains difficult to achieve with current electrospinning technologies.

Roll-to-roll electrospinning technologies typically entail the deposition of electrospun fibers onto a fabric substrate that unwinds from a first roll to a second roll. The substrate typically passes in front of a metal sheet that is grounded or negatively charged during the spinning process, which may result in “over tension” of the substrate as it passes through the apparatus on account of electrical charges accumulated over the substrate that cause high friction between the substrate and the metal sheet collector. This in turn results in stretching of the fabric substrate. Such stretching may unfavorably alter the tension control of the winders and may also subsequently damage the deposited nanofibers as the substrate relaxes.

In addition, in current electrospinning apparatuses a substrate is pulled between an unwinder and a winder while passing over a metal collector plate connected to a high voltage source. Under the influence of the electric field, strong attraction forces between the substrate and the collector plate result in high friction. This friction, combined with the mechanical pulling tension from the winding system, generates excessive stress on the substrate. For expandable substrates, this leads to stretching, distortion, or damage of the nanofiber coating. Additionally, because the process requires continuous pulling, control over winding speed is limited, restricting the ability to achieve uniform multilayer deposition or to operate at very low speeds.

There remains a need for electrospinning systems and apparatuses that overcome the above-described challenges and allow production of nanofibers at high rates.

### SUMMARY

The present disclosure describes electrospinning systems and apparatuses that are suitable for use in high throughput industrial settings. The disclosed systems and apparatuses may include a high voltage power supply having positive and negative electrodes; one or more spinnerets that include one or more convergent-divergent nozzles, one or more turbo canals, or a combination thereof; and a collector. The systems and apparatuses may further include one or more peristaltic pumps. In some implementations, the systems and apparatuses may be designed to produce nanofibers from multiple polymer solutions simultaneously. The collector may be an adjustable collector. The adjustable collector may be composed of multiple metal sheets. The collector may alternately be a conveyor belt collector. The systems and apparatuses may optionally further include one or more of a ventilation system that reduces sparking inside the electrospinning chamber, a chamber for reducing power consumption when using an optional heater or dehumidifier, and an in-line quality control system.

### BRIEF DESCRIPTION OF THE DRAWINGS

FIG. 1 shows an embodiment of the disclosed apparatus.

FIG. 2 shows an embodiment of a peristaltic pump and a schematic representation of a method of phase compensation using multiple peristaltic pumps.

FIG. 3A shows a schematic representation of the configuration of a convergent-divergent nozzle.

FIG. 3B shows an example of a convergent-divergent nozzle.

FIG. 4A shows an example of a turbo canal.

FIG. 4B shows an example of a polymer solution being fed into a turbo canal.

FIG. 5 shows an example of a metal collector composed of four metal sheets.

FIG. 6 shows an example of an in-line quality control system.

FIG. 7 shows an example of a ventilation system of the disclosed electrospinning system.

### DETAILED DESCRIPTION

The present disclosure describes electrospinning systems and apparatuses that are suitable for use in high throughput industrial settings. The disclosed systems and apparatuses may include a high voltage power supply having positive and negative electrodes; one or more spinnerets that include one or more convergent-divergent nozzles, one or more turbo canals, or a combination thereof; and a collector. The systems and apparatuses may further include one or more peristaltic pumps. In some implementations, the systems and apparatuses may be designed to produce nanofibers from multiple polymer solutions simultaneously. The collector may be an adjustable collector. The adjustable collector may be composed of multiple metal sheets. The collector may alternately be a conveyor belt collector. The systems and apparatuses may optionally further include one or more of a ventilation system that reduces sparking inside the electrospinning chamber, a chamber for reducing power consumption when using an optional heater or dehumidifier, and an in-line quality control system.

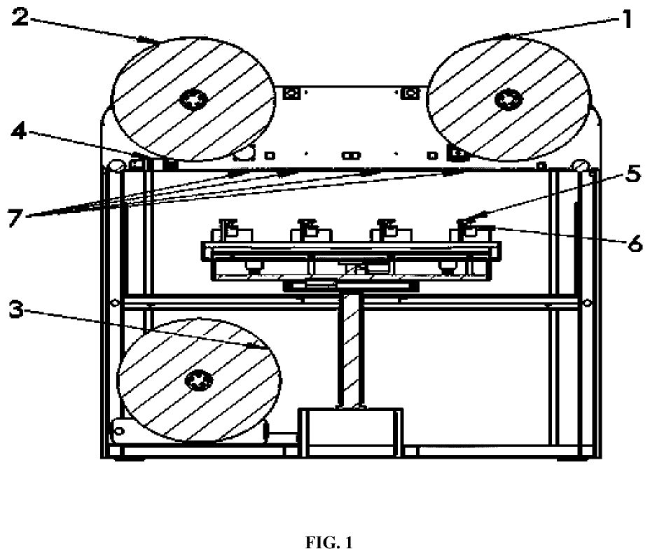

FIG. 1 shows an embodiment of the disclosed electrospinning apparatus, including unwinder 1, winder 2, lamination sandwich 3, quality control module 4, feeder 5, turbo canal 6, and collector plates 7.

In some implementations, the disclosed electrospinning apparatuses use peristaltic pumps to feed the spinneret. This eliminates the need to use syringes. A peristaltic pump can draw a solution from any sized container, which eliminates the need for refilling the polymer solution during the spinning process.

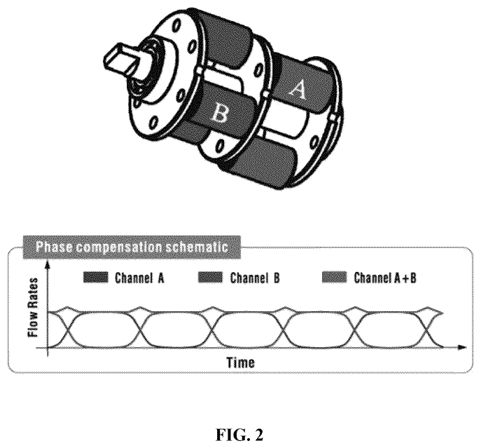

To prevent interruptions and instability of the spinning jet caused by non-continuous feeding of a single peristaltic pump that results from peristaltic movement, multiple peristaltic pumps are used in the disclosed apparatuses. FIG. 2 shows an example of how two peristaltic pumps having a difference in phase may be used with two separate roll sets to provide overall continuous feeding of the polymer solution. As shown, when phase B is idle, phase A is feeding, and vice versa.

In some implementations, the disclosed electrospinning apparatuses provide alternate non-needle spinnerets that may be used interchangeably, thereby increasing productivity. The use of these alternate spinnerets may also prevent early solidification of the electrospun polymer as frequently results when a needle is used as the spinneret.

The alternate spinneret may be a convergent-divergent nozzle, a turbo canal, or another suitable alternate spinneret.

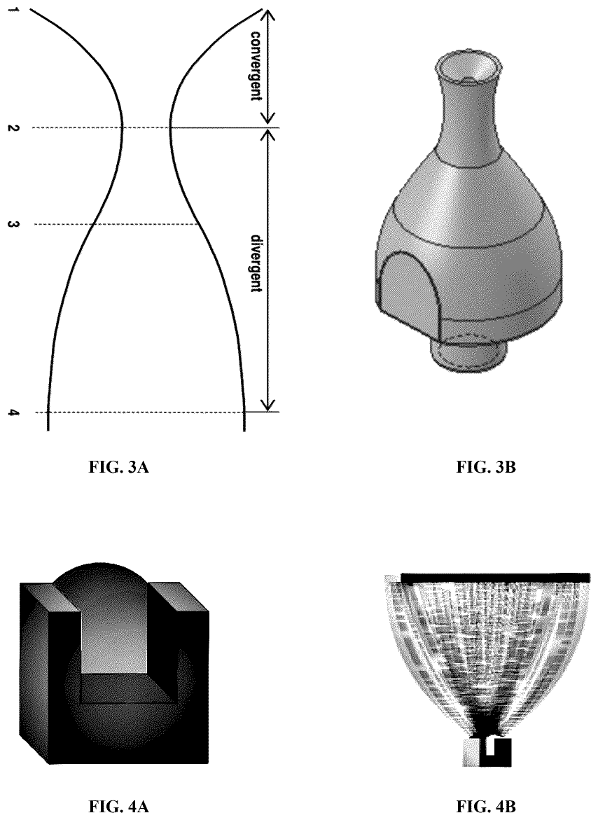

FIG. 3A shows a schematic representation of the configuration of a convergent-divergent nozzle. FIG. 3B shows an example of a convergent-divergent nozzle. The convergent-divergent nozzle is shaped to promote a polymer solution therein to adopt a cone shape. The use of multiple convergent-divergent nozzles in a rod system, where multiple rods are present in a single apparatus, results in the production of many spinning jets, with multiple jets emerging from a single nozzle.

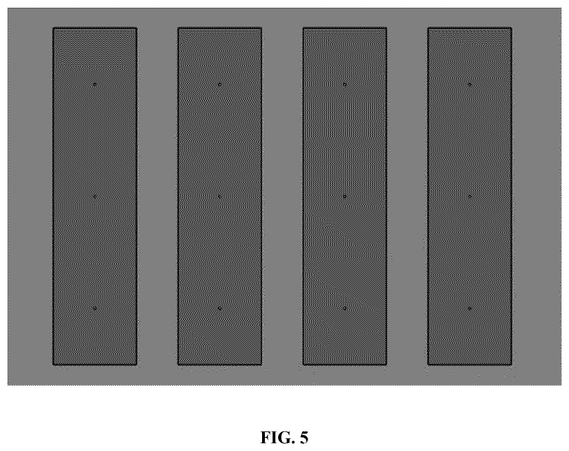

FIG. 4A shows an example of a turbo canal. FIG. 4B shows how a peristaltic pump feeds the U-shaped turbo canal with a polymer solution. Use of a turbo canal may provide one or more advantages over the use of other types of spinnerets, including very high productivity, generation of continuous jets, production of homogeneous material, reduced problems with clogging as may occur with needles or nozzles, and simplicity of setup and cleaning.

The disclosed apparatuses may have one or multiple spinnerets, which may include one or more convergent-divergent nozzles, one or more turbo canals, or a combination thereof. Alternatively, the disclosed apparatuses may have multiple spinnerets that include both needle spinnerets and one or more convergent-divergent nozzles, one or more turbo canals, or a combination thereof.

In some implementations, the disclosed apparatuses have a reduced contact area between the spinneret and the collector as compared to prior art roll-to-roll electrospinning apparatuses. This may be achieved by using multiple metal sheets to form an adjustable collector that allows adjustment and optimization of the gap between the substrate and the collector. By using multiple metal sheets as a collector, the tension on the roll is decreased. The collector may preferably be connected to a negative high voltage electrode to increase the attractiveness of charged fibers.

In some implementations, the adjustable collector adds one layer of the substrate to laminate the surface of the nanofiber layer, thereby protecting it. Nanofiber layers are thus sandwiched between substrate layers. This eliminates the need to laminate a protective layer as a post-process step for many industrial applications.

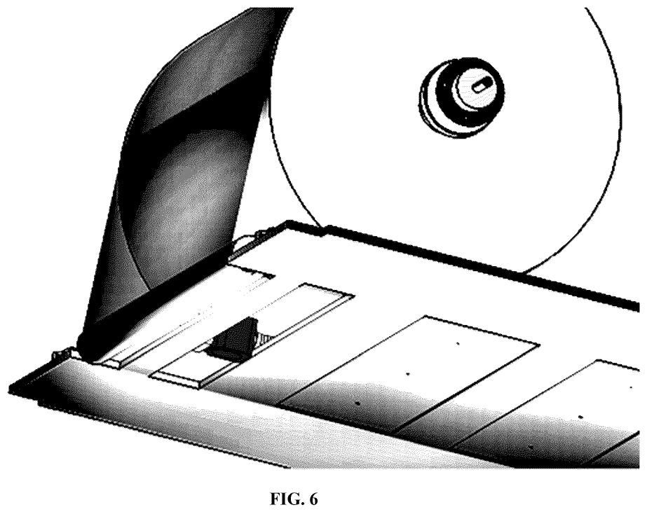

FIG. 5 shows an example of a metal collector composed of four metal sheets.

In some alternate implementations, the disclosed apparatuses may be configured to converge multiple nanofiber jets into a single focal point. In some implementations, such apparatuses include multiple syringe pumps that each deliver a different solution. For example, three syringe pumps that each deliver a different solution may be used. Each syringe pump is preferably connected to a separate high-voltage power supply, ensuring independent control of each syringe pump. In some such implementations, three spinning rods are mounted such that the central rod is fixed while the two side rods are angle-adjustable. The rods are arranged so that the electrospun fibers converge on a common focal point relative to the collector. In some implementations, the collector is a cylindrical (calender-type) electrode with a negative high-voltage potential. The substrate moves along its surface to collect uniform fiber layers. Advantages of such implementations include enabling simultaneous deposition of three different fibers in the same area, producing composite or layered nanofiber structures directly during electrospinning, and providing adjustable geometry for optimal convergence and deposition accuracy.

In some other alternate implementations, the disclosed apparatuses may include a conveyor belt collector instead of a metal plate unwinder-winder collector. In such implementations, an electrically grounded or negatively charged conveyor belt moves beneath the electrospinning field. Because the substrate rests directly on the conveyor and is not pulled against a fixed metal plate, friction is drastically reduced. The conveyor operates without generating the excessive mechanical stress found in plate-based collectors. Using the conveyor belt collector, substrates may be transported smoothly with minimal tension, or the system may alternately operate without a substrate, directly depositing nanofibers on the conveyor surface to form a free-standing nanofiber mat. In some implementations, the conveyor is configured to be cycled multiple times under the spinning zone, allowing precise buildup of multilayer coatings or mats.

Advantages of the conveyor belt collector include elimination of frictional forces caused by traditional metal collector plates, prevention of substrate stretching, distortion, and coating damage, enabling ultra-low-speed collection for improved uniformity, allowing repeated passes to create thick, multilayer nanofiber coatings or free-standing mats, providing more precise control over fiber thickness and homogeneity compared to unwinder-winder systems, and extending the range of usable substrates, including delicate and expandable materials.

In some implementations of the conveyor belt collector, the conveyor belt collector is built around a conductive steel belt that is mounted on rollers and is guided by a mechanical alignment system using lens-shaped bolts. The collector is specifically designed for electrospinning nanofibers, where high surface quality, conductivity, and precise belt tracking are essential.

In some implementations of the conveyor belt collector, a conductive steel belt about 0.25 mm thick is used. The steel belt may, for example, be composed of a spring stainless steel sheet with its ends joined by automated fiber laser welding with a polished joint surface. In some implementations, laser welding is performed using automated laser equipment with an edge-holding fixture, which produces a uniform and homogeneous weld seam. In some implementations, the steel surface is polished after welding, which imparts resistance to electrospinning solution droplets and residues and thereby allows long-term operation without requiring frequent cleaning. Polishing allows generation of uniform, defect-free nanofiber coatings. Use of a laser-welded steel belt provides several advantages, including excellent conductivity for the high-voltage connection, optimal thickness for a balance between flexibility and durability, a smooth surface that prevents patterns in nanofiber coatings collected by the collector, a continuous conductive path without surface irregularities via the polished laser weld, and a stronger joint compared to copper or PTFE belts to prevent premature breakage. Advantages of using automated fiber laser welding include generating a reliable, reproducible, and smooth joint, eliminating the need for heavy sanding that may weaken the joint, increased belt lifetime, and reduced maintenance requirements.

In some implementations of the conveyor belt collector, large diameter rollers may be used. The rollers may be driven or non-driven. The diameter of the rollers may, for example, be about 100 mm. Rollers having a diameter of 100 mm reduce bending stress on the belt compared to smaller diameter rollers such as 50 mm rollers, which reduces fatigue cracking at the weld joint, provides smooth and uniform belt motion, and extends the lifetime of the belt.

In some implementations of the conveyor belt collector, a mechanical alignment guide composed of lens-shaped bolts is used. Holes are added along the edges of the steel belt. The rollers are machined with threaded holes. Lens-shaped bolts are inserted into the rollers to engage the belt holes, guiding the belt laterally. Advantages of this design include positive mechanical alignment that prevents drift to one side and maintaining consistent belt positioning even under bidirectional operation. The use of lens-shaped bolts was found to resolve alignment issues that could not be resolved using tension bolts, crowned rollers, and/or PU belts. In some implementations, lubrication is used to minimize friction and noise.

In some implementations of the conveyor belt collector, the collector has a compact design. In some implementations, the conveyor belt collector has a modular design, allowing interchangeability with other collectors for electrospinning apparatuses that require multiple collectors. Advantages of such designs include case of collector replacement and a compact footprint that allows flexible integration into small electrospinning apparatuses. This facilitates applications and experiments requiring different collector types.

In some implementations of the conveyor belt collector, the belt velocity and direction is adjustable. The belt may, for example, be able to move at a velocity between about 1-100 s. The belt may be bidirectional, such that it can operate in a both left-to-right and right-to-left directions. This allows the electrospinning apparatus to support a wide range of electrospinning parameters and enables reproducible applications and experiments under varying deposition conditions. Bidirectionality of the conveyor belt increases flexibility and usability.

Other features of the disclosed apparatuses may include a ventilation system that reduces sparking inside the electrospinning chamber, a chamber for reducing power consumption when using an optional heater or dehumidifier, a compact size that is suitable for both research and industrial use, and an in-line quality control system that includes a scanner for measuring the differential pressure between the two surfaces of the substrate to determine the level of homogeneity of fibers produced.

FIG. 6 shows an example of an in-line quality control system of the disclosed electrospinning system.

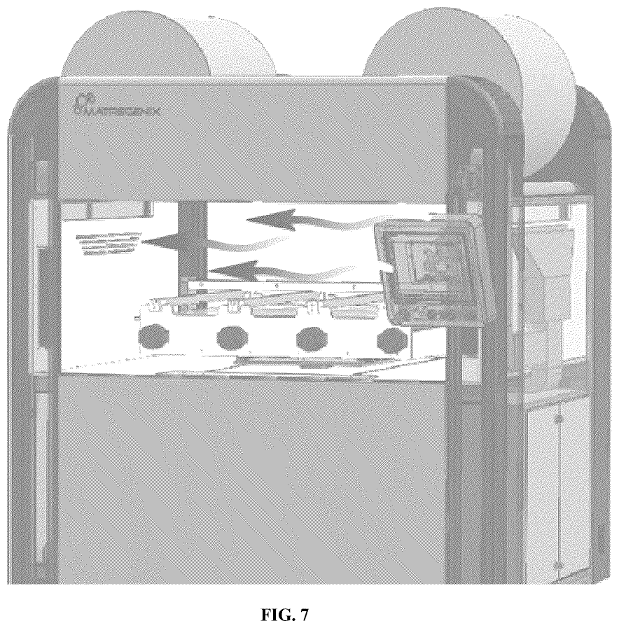

FIG. 7 shows an example of a ventilation system of the disclosed electrospinning system.

### Examples

The following numbered examples further illustrate implementations of the disclosed systems.

Example 1. An electrospinning system that includes a high voltage power supply that includes a positive electrode and a negative electrode, one or more spinnerets, and an adjustable collector, where the one or more spinnerets include at least one spinneret that is a convergent-divergent nozzle or a turbo canal, is disclosed.

Example 2. The system of Example 1, where the adjustable collector is composed of multiple metal sheets is disclosed.

Example 3. The system of Examples 1 or 2, where the system includes at least two spinnerets and at least one spinneret is a convergent-divergent nozzle and at least one spinneret is a turbo canal, is disclosed.

Example 4. The system of Examples 1 or 2, where the system includes at least two spinnerets and at least one spinneret is a convergent-divergent nozzle or a turbo canal, is disclosed.

Example 5. The system of any of Examples 1˜4 further including at least one peristaltic pump which feeds a polymer solution into one or more spinnerets is disclosed.

Example 6. The system of any of Examples 1˜4 further including at least two peristaltic pumps which each feed a polymer solution into one or more spinnerets, where at least two peristaltic pumps have a difference in phase that allows continuous feeding of a polymer solution, is disclosed.

Example 7. The system of any of Examples 1-6 further including a ventilation system is disclosed.

Example 8. The system of any of Examples 1-7 further including a chamber for reducing power consumption is disclosed.

Example 9. The system of any of Examples 1-8 further including an in-line quality control system is disclosed.

Example 10. The system of Example 9, where the in-line quality control system includes a scanner for measuring a differential pressure between the two surfaces of a substrate to determine a level of homogeneity of nanofibers produced is disclosed.

Example 11. An electrospinning system that includes a high voltage power supply that includes a positive electrode and a negative electrode, one or more spinnerets, and a collector, where the one or more spinnerets include at least one spinneret that is a convergent-divergent nozzle or a turbo canal, is disclosed.

Example 12. The system of Example 11, where the system includes at least two spinnerets and at least one spinneret is a convergent-divergent nozzle and at least one spinneret is a turbo canal, is disclosed.

Example 13. The system of Example 11, where the system includes at least two spinnerets and at least one spinneret is a convergent-divergent nozzle or a turbo canal, is disclosed.

Example 14. The system of any of Examples 11-13 further including at least one peristaltic pump which feeds a polymer solution into one or more spinnerets is disclosed.

Example 15. The system of any of Examples 11-13 further including at least two peristaltic pumps which each feed a polymer solution into one or more spinnerets, where at least two peristaltic pumps have a difference in phase that allows continuous feeding of a polymer solution, is disclosed.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Further, any range of numbers recited above describing or claiming various aspects of the invention, such as ranges that represent a particular set of properties, units of measure, conditions, physical states, or percentages, is intended to literally incorporate any number falling within such range, including any subset of numbers or ranges subsumed within any range so recited. As used herein, the terms “about” and “approximately” when used as modifiers are intended to convey that the numbers and ranges disclosed herein may be flexible as understood by ordinarily skilled artisans and that practice of the disclosed invention by ordinarily skilled artisans using properties that are outside of a literal range will achieve the desired result. The use of “about” or “approximately” as modifiers refers to known commercial and/or experimental measurement variations or tolerances for the referenced quantity. In some embodiments, such known commercial and/or experimental measurement tolerances are ±10% of the measured value, while in other embodiments such known commercial and/or experimental measurement tolerances are ±5% of the measured value, while in still other embodiments such known commercial and/or experimental measurement tolerances are ±2.5% of the measured value, and in still other embodiments, such known commercial and/or experimental measurement tolerances are ±1% of the measured value.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Each of the foregoing and various aspects, together with those summarized above or otherwise disclosed herein, including the figures, may be combined without limitation to form claims for a device, apparatus, system, method of manufacture, and/or method of use. All references cited herein are hereby expressly incorporated by reference.

What is claimed is:

1. An electrospinning system comprising:
a. a high voltage power supply that includes a positive electrode and a negative electrode;
b. one or more spinnerets; and
c. an adjustable collector;
wherein the one or more spinnerets include at least one spinneret that is a convergent-divergent nozzle or a turbo canal.

2. The system of claim 1, wherein the adjustable collector is composed of multiple metal sheets.

3. The system of claim 1, wherein the system includes at least two spinnerets and at least one spinneret is a convergent-divergent nozzle and at least one spinneret is a turbo canal.

4. The system of claim 1, wherein the system includes at least two spinnerets and at least one spinneret is a convergent-divergent nozzle or a turbo canal.

5. The system of claim 1 further comprising at least one peristaltic pump which feeds a polymer solution into one or more spinnerets.

6. The system of claim 1 further comprising at least two peristaltic pumps which each feed a polymer solution into one or more spinnerets, wherein at least two peristaltic pumps have a difference in phase that allows continuous feeding of a polymer solution.

7. The system of claim 6 further comprising a ventilation system.

8. The system of claim 7 further comprising a chamber for reducing power consumption.

9. The system of claim 8 further comprising an in-line quality control system.

10. The system of claim 9, wherein the in-line quality control system includes a scanner for measuring a differential pressure between the two surfaces of a substrate to determine a level of homogeneity of nanofibers produced.

11. An electrospinning system comprising:
a. a high voltage power supply that includes a positive electrode and a negative electrode;
b. one or more spinnerets; and
c. a collector;
wherein the one or more spinnerets include at least one spinneret that is a convergent-divergent nozzle or a turbo canal.

12. The system of claim 11, wherein the system includes at least two spinnerets and at least one spinneret is a convergent-divergent nozzle and at least one spinneret is a turbo canal.

13. The system of claim 11, wherein the system includes at least two spinnerets and at least one spinneret is a convergent-divergent nozzle or a turbo canal.

14. The system of claim 11 further comprising at least one peristaltic pump which feeds a polymer solution into one or more spinnerets.

15. The system of claim 11 further comprising at least two peristaltic pumps which each feed a polymer solution into one or more spinnerets, wherein at least two peristaltic pumps have a difference in phase that allows continuous feeding of a polymer solution.
